(19) United States
(12) Patent Application Publication
(10) Pub. No.: US 2025/0175923 A1
(43) Pub. Date: May 29, 2025

(54) APPARATUS, METHOD, AND COMPUTER PROGRAM

(71) Applicant: Nokia Technologies Oy, Espoo (FI)

(72) Inventors: Saurabh KHARE, Bangalore, IN (US); Bruno LANDAIS, Lannion (FR); Alexander MILINSKI, Munich (DE); Laurent THIÉBAUT, Massy (FR); Pallab GUPTA, Bangalore (IN)

(21) Appl. No.: 18/940,084

(22) Filed: Nov. 7, 2024

(30) Foreign Application Priority Data
Nov. 23, 2023 (IN) 202341079561

(51) Int. Cl. H04W 60/04; H04L 65/1016; H04W 8/04

(52) U.S. Cl. CPC H04W 60/04; H04L 65/1016; H04W 8/04

(57) ABSTRACT

There is provided an apparatus, method, and computer program for determining, an identifier of an access and mobility management function serving a user equipment for a registration associated with an internet protocol multimedia subsystem, IMS, service, while the user equipment may for the same subscription have also other registrations not associated with an internet protocol multimedia subsystem, IMS, service.

### TECHNICAL FIELD

Various examples of this subject disclosure generally relate to apparatus, methods, and computer programs, and more particularly (but not exclusively) to apparatus, methods and computer programs for apparatus.

### BACKGROUND

A communication system can be seen as a facility that enables communication sessions between two or more entities, such as communication devices, base stations and/or other nodes, by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets forth what the various entities associated with the system are permitted to do and how that should be achieved. Communication protocols and/or parameters which shall be used for the connection are also typically defined therein. Examples include the so-called 5G standards.

### SUMMARY

Some examples of the subject disclosure are described with respect to certain aspects. These aspects are not intended to indicate key or essential features of the various example of the subject disclosure, nor are they intended to be used to limit the scope thereof. Other features, aspects and elements will be readily apparent to a person skilled in the art in view of the subject disclosure.

According to a first aspect, there is provided an apparatus comprising means for performing: receiving, from a first access and mobility management function, a first registration request for registering that the first access and mobility management function is to serve a user equipment, the first registration request comprising a first registration identifier; receiving information indicating that the registration corresponding to the first registration request is associated with an internet protocol multimedia subsystem, IMS, service; receiving, from a network entity, a request for information related with an IMS service; determining a registration identifier and access and mobility management function for the related IMS service; obtaining said information for the related IMS service from the determined access and mobility management function by providing the determined registration identifier to the determined access and mobility management function; and providing the requested information to the network entity.

The receiving information indicating that the registration corresponding to the first registration request is associated with an IMS service may comprise means for: receiving a second registration request for said user equipment, the second registration request comprising the first registration identifier and information indicating that the packet data unit session is for an IMS service.

The receiving information indicating that the registration corresponding to the first registration request is associated with an IMS service may comprise means for: receiving, from a session management function, the second registration request, the second registration request comprising information for registering that the session management function is to serve a packet data unit session for said user equipment, the second registration request comprising the first registration identifier and information indicating that the packet data unit session is for an IMS service.

The apparatus may further comprise means for storing, for the user equipment, an association between the related IMS service and the received information indicating that the registration corresponding to the first registration request is associated with the IMS session.

The apparatus may further comprise means for identifying the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service.

The means for receiving information indicating that the registration corresponding to the first registration request is associated with an IMS service may comprise means for: receiving, in the first registration request, information indicating that the registration corresponding to the first registration request is associated with an IMS service.

The information indicating that the session is for an IMS service may comprise an indication that the session is for an IMS service.

The network entity may be configured to operate as a home subscriber system or an application server.

The means for obtaining may comprise means for: signalling, to the first access and mobility management function, a request for information associated with the first registration identifier; and receiving, from the first access and mobility management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

According to a second aspect, there is provided an apparatus comprising means for performing: providing, to a unified data management function, a first registration request for registering that an access and mobility management function is to serve a user equipment, the first registration request comprising a first registration identifier, wherein the apparatus is comprised in the access and mobility management function.

The first registration request may comprise information indicating that the registration identifier is associated with an Internet Protocol Multimedia Subsystem, IMS, service.

The apparatus may further comprise means for performing at least one of the following: receiving, from the user equipment, information indicating that the first registration request is associated with the user equipment's registration to a core network for an internet protocol multimedia subsystem, IMS, service; or determining that the first registration request is associated with an internet protocol multimedia subsystem, IMS, service based on a packet data unit session established for the user equipment for a data network name and/or a network slice identifier corresponding to the IMS service.

The information indicating that the session is for an IMS service may comprise an indication that the session is for an IMS service, wherein the indication is based on the information received from the user equipment.

The apparatus may further comprise means for: receiving, from the unified data management function, a request for information associated with the first registration identifier; and signalling, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The apparatus may further comprise means for performing providing the first registration identifier in a packet data unit session establishment or modification request to a session management function.

According to a third aspect, there is provided an apparatus comprising means for performing: providing, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service, wherein the apparatus is comprised in a session management function.

The apparatus may comprise means for receiving the first registration identifier in a packet data unit session establishment or modification request from an access and mobility management function that is to serve said user equipment.

The information indicating that the session is for an IMS service may comprise an indication that the session is for an IMS service.

The information indicating that the session is for an IMS service may comprise a data network name and/or a network slice identifier usable for the IMS service.

According to a fourth aspect, there is provided an apparatus comprising means for performing: sending, to an access and mobility management function, information indicating that a first registration is associated with the user equipment's registration to a core network for an internet protocol multimedia subsystem, IMS, service, wherein the apparatus is comprised in a user equipment.

According to a fifth aspect, there is provided an apparatus, the apparatus comprising: at least one processor; and at least one memory comprising code that, when executed by the at least one processor, causes the apparatus to perform: receiving, from a first access and mobility management function, a first registration request for registering that the first access and mobility management function is to serve a user equipment, the first registration request comprising a first registration identifier; receiving information indicating that the registration corresponding to the first registration request is associated with an internet protocol multimedia subsystem, IMS, service; receiving, from a network entity, a request for information related with an IMS service; determining a registration identifier and access and mobility management function for the related IMS service; obtaining said information for the related IMS service from the determined access and mobility management function by providing the determined registration identifier to the determined access and mobility management function; and providing the requested information to the network entity.

The receiving information indicating that the registration corresponding to the first registration request is associated with an IMS service may comprise: receiving a second registration request for said user equipment, the second registration request comprising the first registration identifier and information indicating that the packet data unit session is for an IMS service.

The receiving information indicating that the registration corresponding to the first registration request is associated with an IMS service may comprise: receiving, from a session management function, the second registration request, the second registration request comprising information for registering that the session management function is to serve a packet data unit session for said user equipment, the second registration request comprising the first registration identifier and information indicating that the packet data unit session is for an IMS service.

The apparatus may further be caused to perform: storing, for the user equipment, an association between the related IMS service and the received information indicating that the registration corresponding to the first registration request is associated with the IMS session.

The apparatus may further be caused to perform: identifying the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service.

The receiving information indicating that the registration corresponding to the first registration request is associated with an IMS service may comprise: receiving, in the first registration request, information indicating that the registration corresponding to the first registration request is associated with an IMS service.

The information indicating that the session is for an IMS service may comprise an indication that the session is for an IMS service.

The network entity may be configured to operate as a home subscriber system or an application server.

The obtaining may comprise: signalling, to the first access and mobility management function, a request for information associated with the first registration identifier; and receiving, from the first access and mobility management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

According to a sixth aspect, there is provided an apparatus, the apparatus comprising: at least one processor; and at least one memory comprising code that, when executed by the at least one processor, causes the apparatus to perform: providing, to a unified data management function, a first registration request for registering that an access and mobility management function is to serve a user equipment, the first registration request comprising a first registration identifier, wherein the apparatus is comprised in the access and mobility management function.

The first registration request may comprise information indicating that the registration identifier is associated with an Internet Protocol Multimedia Subsystem, IMS, service.

The apparatus may further be caused to perform at least one of the following: receiving, from the user equipment, information indicating that the first registration request is associated with the user equipment's registration to a core network for an internet protocol multimedia subsystem, IMS, service; or determining that the first registration request is associated with an internet protocol multimedia subsystem, IMS, service based on a packet data unit session established for the user equipment for a data network name and/or a network slice identifier corresponding to the IMS service.

The information indicating that the session is for an IMS service may comprise an indication that the session is for an IMS service, wherein the indication is based on the information received from the user equipment.

The apparatus may further be caused to perform: receiving, from the unified data management function, a request for information associated with the first registration identifier; and signalling, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The apparatus may further be caused to perform: providing the first registration identifier in a packet data unit session establishment or modification request to a session management function.

According to a seventh aspect, there is provided an apparatus, the apparatus comprising: at least one processor; and at least one memory comprising code that, when executed by the at least one processor, causes the apparatus to perform: providing, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service, wherein the apparatus is comprised in a session management function.

The apparatus may further be caused to perform: receiving the first registration identifier in a packet data unit session establishment or modification request from an access and mobility management function that is to serve said user equipment.

The information indicating that the session is for an IMS service may comprise an indication that the session is for an IMS service.

The information indicating that the session is for an IMS service may comprise a data network name and/or a network slice identifier usable for the IMS service.

According to an eighth aspect, there is provided an apparatus, the apparatus comprising: at least one processor; and at least one memory comprising code that, when executed by the at least one processor, causes the apparatus to perform: sending, to an access and mobility management function, information indicating that a first registration is associated with the user equipment's registration to a core network for an internet protocol multimedia subsystem, IMS, service, wherein the apparatus is comprised in a user equipment.

According to a ninth aspect, there is provided a method for an apparatus, the method comprising: receiving, from a first access and mobility management function, a first registration request for registering that the first access and mobility management function is to serve a user equipment, the first registration request comprising a first registration identifier; receiving information indicating that the registration corresponding to the first registration request is associated with an internet protocol multimedia subsystem, IMS, service; receiving, from a network entity, a request for information related with an IMS service; determining a registration identifier and access and mobility management function for the related IMS service; obtaining said information for the related IMS service from the determined access and mobility management function by providing the determined registration identifier to the determined access and mobility management function; and providing the requested information to the network entity.

The receiving information indicating that the registration corresponding to the first registration request is associated with an IMS service may comprise: receiving a second registration request for said user equipment, the second registration request comprising the first registration identifier and information indicating that the packet data unit session is for an IMS service.

The receiving information indicating that the registration corresponding to the first registration request is associated with an IMS service may comprise: receiving, from a session management function, the second registration request, the second registration request comprising information for registering that the session management function is to serve a packet data unit session for said user equipment, the second registration request comprising the first registration identifier and information indicating that the packet data unit session is for an IMS service.

The method may further comprise: storing, for the user equipment, an association between the related IMS service and the received information indicating that the registration corresponding to the first registration request is associated with the IMS session.

The method may further comprise: identifying the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service.

The receiving information indicating that the registration corresponding to the first registration request is associated with an IMS service may comprise: receiving, in the first registration request, information indicating that the registration corresponding to the first registration request is associated with an IMS service.

The information indicating that the session is for an IMS service may comprise an indication that the session is for an IMS service.

The network entity may be configured to operate as a home subscriber system or an application server.

The obtaining may comprise: signalling, to the first access and mobility management function, a request for information associated with the first registration identifier; and receiving, from the first access and mobility management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

According to a tenth aspect, there is provided a method for an apparatus, the method comprising: providing, to a unified data management function, a first registration request for registering that an access and mobility management function is to serve a user equipment, the first registration request comprising a first registration identifier, wherein the apparatus is comprised in the access and mobility management function.

The first registration request may comprise information indicating that the registration identifier is associated with an Internet Protocol Multimedia Subsystem, IMS, service.

The method may further comprise at least one of the following: receiving, from the user equipment, information indicating that the first registration request is associated with the user equipment's registration to a core network for an internet protocol multimedia subsystem, IMS, service; or determining that the first registration request is associated with an internet protocol multimedia subsystem, IMS, service based on a packet data unit session established for the user equipment for a data network name and/or a network slice identifier corresponding to the IMS service.

The information indicating that the session is for an IMS service may comprise an indication that the session is for an IMS service, wherein the indication is based on the information received from the user equipment.

The method may further comprise: receiving, from the unified data management function, a request for information associated with the first registration identifier; and signalling, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The method may further comprise: providing the first registration identifier in a packet data unit session establishment or modification request to a session management function.

According to an eleventh aspect, there is provided a method for an apparatus, the method comprising means: providing, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service, wherein the apparatus is comprised in a session management function.

The method may further comprise: receiving the first registration identifier in a packet data unit session establishment or modification request from an access and mobility management function that is to serve said user equipment.

The information indicating that the session is for an IMS service may comprise an indication that the session is for an IMS service.

The information indicating that the session is for an IMS service may comprise a data network name and/or a network slice identifier usable for the IMS service.

According to a twelfth aspect, there is provided a method for an apparatus, the method comprising: sending, to an access and mobility management function, information indicating that a first registration is associated with the user equipment's registration to a core network for an internet protocol multimedia subsystem, IMS, service, wherein the apparatus is comprised in a user equipment.

According to a thirteenth aspect, there is provided an apparatus, the apparatus comprising: receiving circuitry for receiving, from a first access and mobility management function, a first registration request for registering that the first access and mobility management function is to serve a user equipment, the first registration request comprising a first registration identifier; receiving circuitry for receiving information indicating that the registration corresponding to the first registration request is associated with an internet protocol multimedia subsystem, IMS, service; receiving circuitry for receiving, from a network entity, a request for information related with an IMS service; determining a registration identifier and access and mobility management function for the related IMS service; obtaining circuitry for obtaining said information for the related IMS service from the determined access and mobility management function by providing the determined registration identifier to the determined access and mobility management function; and providing circuitry for providing the requested information to the network entity.

The receiving circuitry for receiving information indicating that the registration corresponding to the first registration request is associated with an IMS service may comprise: receiving circuitry for receiving a second registration request for said user equipment, the second registration request comprising the first registration identifier and information indicating that the packet data unit session is for an IMS service.

The receiving circuitry for receiving information indicating that the registration corresponding to the first registration request is associated with an IMS service may comprise: receiving circuitry for receiving, from a session management function, the second registration request, the second registration request comprising information for registering that the session management function is to serve a packet data unit session for said user equipment, the second registration request comprising the first registration identifier and information indicating that the packet data unit session is for an IMS service.

The apparatus may further comprise storing circuitry for storing, for the user equipment, an association between the related IMS service and the received information indicating that the registration corresponding to the first registration request is associated with the IMS session.

The apparatus may further comprise identifying circuitry for identifying the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service.

The receiving circuitry for receiving information indicating that the registration corresponding to the first registration request is associated with an IMS service may comprise: receiving circuitry for receiving, in the first registration request, information indicating that the registration corresponding to the first registration request is associated with an IMS service.

The information indicating that the session is for an IMS service may comprise an indication that the session is for an IMS service.

The network entity may be configured to operate as a home subscriber system or an application server.

The obtaining circuitry for obtaining may comprise: signalling circuitry for signalling, to the first access and mobility management function, a request for information associated with the first registration identifier; and receiving circuitry for receiving, from the first access and mobility management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

According to a fourteenth aspect, there is provided an apparatus comprising: providing circuitry for providing, to a unified data management function, a first registration request for registering that an access and mobility management function is to serve a user equipment, the first registration request comprising a first registration identifier, wherein the apparatus is comprised in the access and mobility management function.

The first registration request may comprise information indicating that the registration identifier is associated with an Internet Protocol Multimedia Subsystem, IMS, service.

The apparatus may further comprise at least one of the following: receiving circuitry for receiving, from the user equipment, information indicating that the first registration request is associated with the user equipment's registration to a core network for an internet protocol multimedia subsystem, IMS, service; or determining circuitry for determining that the first registration request is associated with an internet protocol multimedia subsystem, IMS, service based on a packet data unit session established for the user equipment for a data network name and/or a network slice identifier corresponding to the IMS service.

The information indicating that the session is for an IMS service may comprise an indication that the session is for an IMS service, wherein the indication is based on the information received from the user equipment.

The apparatus may further comprise: receiving circuitry for receiving, from the unified data management function, a request for information associated with the first registration identifier; and signalling circuitry for signalling, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The apparatus may further comprise providing circuitry for providing the first registration identifier in a packet data unit session establishment or modification request to a session management function.

According to a fifteenth aspect, there is provided an apparatus comprising: providing circuitry for providing, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service, wherein the apparatus is comprised in a session management function.

The apparatus may comprise receiving circuitry for receiving the first registration identifier in a packet data unit session establishment or modification request from an access and mobility management function that is to serve said user equipment.

The information indicating that the session is for an IMS service may comprise an indication that the session is for an IMS service.

The information indicating that the session is for an IMS service may comprise a data network name and/or a network slice identifier usable for the IMS service.

According to a sixteenth aspect, there is provided an apparatus comprising: sending circuitry for sending, to an access and mobility management function, information indicating that a first registration is associated with the user equipment's registration to a core network for an internet protocol multimedia subsystem, IMS, service, wherein the apparatus is comprised in a user equipment.

According to a seventeenth aspect, there is provided non-transitory computer readable medium comprising program instructions for causing an apparatus to perform: receiving, from a first access and mobility management function, a first registration request for registering that the first access and mobility management function is to serve a user equipment, the first registration request comprising a first registration identifier; receiving information indicating that the registration corresponding to the first registration request is associated with an internet protocol multimedia subsystem, IMS, service; receiving, from a network entity, a request for information related with an IMS service; determining a registration identifier and access and mobility management function for the related IMS service; obtaining said information for the related IMS service from the determined access and mobility management function by providing the determined registration identifier to the determined access and mobility management function; and providing the requested information to the network entity.

The receiving information indicating that the registration corresponding to the first registration request is associated with an IMS service may comprise: receiving a second registration request for said user equipment, the second registration request comprising the first registration identifier and information indicating that the packet data unit session is for an IMS service.

The receiving information indicating that the registration corresponding to the first registration request is associated with an IMS service may comprise: receiving, from a session management function, the second registration request, the second registration request comprising information for registering that the session management function is to serve a packet data unit session for said user equipment, the second registration request comprising the first registration identifier and information indicating that the packet data unit session is for an IMS service.

The apparatus may further be caused to perform: storing, for the user equipment, an association between the related IMS service and the received information indicating that the registration corresponding to the first registration request is associated with the IMS session.

The apparatus may further be caused to perform: identifying the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service.

The receiving information indicating that the registration corresponding to the first registration request is associated with an IMS service may comprise: receiving, in the first registration request, information indicating that the registration corresponding to the first registration request is associated with an IMS service.

The information indicating that the session is for an IMS service may comprise an indication that the session is for an IMS service.

The network entity may be configured to operate as a home subscriber system or an application server.

The obtaining may comprise: signalling, to the first access and mobility management function, a request for information associated with the first registration identifier; and receiving, from the first access and mobility management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

According to an eighteenth aspect, there is provided an apparatus, the apparatus comprising: at least one processor; and at least one memory comprising there is provided non-transitory computer readable medium comprising program instructions for causing an apparatus to perform: providing, to a unified data management function, a first registration request for registering that an access and mobility management function is to serve a user equipment, the first registration request comprising a first registration identifier, wherein the apparatus is comprised in the access and mobility management function.

The first registration request may comprise information indicating that the registration identifier is associated with an Internet Protocol Multimedia Subsystem, IMS, service.

The apparatus may further be caused to perform at least one of the following: receiving, from the user equipment, information indicating that the first registration request is associated with the user equipment's registration to a core network for an internet protocol multimedia subsystem, IMS, service; or determining that the first registration request is associated with an internet protocol multimedia subsystem, IMS, service based on a packet data unit session established for the user equipment for a data network name and/or a network slice identifier corresponding to the IMS service.

The information indicating that the session is for an IMS service may comprise an indication that the session is for an IMS service, wherein the indication is based on the information received from the user equipment.

The apparatus may further be caused to perform: receiving, from the unified data management function, a request for information associated with the first registration identifier; and signalling, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The apparatus may further be caused to perform: providing the first registration identifier in a packet data unit session establishment or modification request to a session management function.

According to a nineteenth aspect, there is provided non-transitory computer readable medium comprising program instructions for causing an apparatus to perform: providing, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service, wherein the apparatus is comprised in a session management function.

The apparatus may further be caused to perform: receiving the first registration identifier in a packet data unit session establishment or modification request from an access and mobility management function that is to serve said user equipment.

The information indicating that the session is for an IMS service may comprise an indication that the session is for an IMS service.

The information indicating that the session is for an IMS service may comprise a data network name and/or a network slice identifier usable for the IMS service.

According to a twentieth aspect, there is provided non-transitory computer readable medium comprising program instructions for causing an apparatus to perform: sending, to an access and mobility management function, information indicating that a first registration is associated with the user equipment's registration to a core network for an internet protocol multimedia subsystem, IMS, service, wherein the apparatus is comprised in a user equipment.

According to a twenty first aspect, there is provided a computer program product stored on a medium that may cause an apparatus to perform any method as described herein.

According to a twenty second aspect, there is provided an electronic device that may comprise apparatus as described herein.

According to a twenty third aspect, there is provided a chipset that may comprise an apparatus as described herein.

In the above, many different aspects have been described. It should be appreciated that further aspects may be provided by the combination of any two or more of the aspects described above

### BRIEF DESCRIPTION OF FIGURES

Some examples will now be described, merely by way of illustration only, with reference to the accompanying drawings in which:

FIGS. 1A-1C show example representations of a 5G system;

FIG. 2 shows an example representation of a network apparatus;

FIG. 3 shows an example representation of a user equipment;

FIGS. 4 to 6 show example signalling; and

FIGS. 7 to 10 illustrate operations that may be performed by example apparatus.

### DETAILED DESCRIPTION

Various examples of the subject disclosure are further described. It is to be understood that these examples are described for the purpose of illustration and to aid those skilled in the art to understand and implement the subject disclosure, without suggesting any specific limitation as to the scope of the subject disclosure. Examples described herein can be implemented in various manners other than the ones described below.

The terminology used herein is generally provided the purpose of describing particular examples only and is not intended to be limiting. In the following description and claims, all technical and scientific terms used herein have the same meaning as commonly understood by one of ordinary skill in the art to which this subject disclosure pertains, unless otherwise defined.

It shall be understood that although the terms “first,” “second,” and the like may be used herein to describe various elements, these elements should not be limited by these terms. These terms are only used to distinguish one element from another. A “first” element could be termed a “second” element, and similarly, a “second” element could be termed a “first” element, without departing from the scope of subject disclosure.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The following describes example operations that may be performed enabling (or otherwise facilitating) the identification of which access registration is used for Internet Protocol Multimedia Subsystem (IMS) services.

For example, in the following, there is disclosed a registry (e.g., a unified data management entity) that, using a registration identifier, maintains an identification of an access and mobility management function (AMF) that is registered as managing the access of a User Equipment (UE) using IMS services via a specified access.

This identification may be maintained and/or established in any of a plurality of different ways, as described herein.

For example, when a UE registers with an AMF, the UE may send, to the AMF, an indication that the registration is for an IMS service. The indication may, in some examples, comprise a registration identifier. In some examples, the AMF and a Session and Mobility Function (SMF) may both register a same registration identifier at the UDM, with the SMF indicating that a session that has been established, by the SMF, for the UE is for an IMS service. In some examples, the AMF may send, to the SMF, the registration identifier for the SMF to use during registration at the UDM. The UDM may determine that the AMF is registered as managing the access of the UE using IMS services by correlating the received registration identifiers and using the indication provided by the SMF to determine that the AMF is managing the access of the UE using an IMS service.

In some examples disclosed herein, there may be a plurality of SMFs serving PDU session(s) for the UE. The AMF may send the registration identifier to each of the plurality of SMFs. In some examples, at least one of the plurality of SMFs may send the registration identifier to the UDM. In other examples, each of the plurality of SMFs may send the registration identifier to the UDM, but only one of the plurality of SMFs may indicate that the registration is for an IMS service.

As another example disclosed herein, when a UE indicates to an AMF that a specific access is for provision of an IMS service, the AMF may directly provide information to the UDM to register with the UDM that the AMF is managing the access of the UE using an IMS service via the specific access. The AMF may provide this information, for example, when the AMF registers at the UDM as managing the access of the UE.

The registry may later receive a request from an application server to determine whether a call can be provided using an IMS service (i.e. the call can be terminated as voice over internet protocol (VoIP) in IMS) or whether a break out to a circuit switched domain is required. In response, the registry may query the AMF to determine whether the call can be provided using an IMS service. In the case of there being two or more possible AMFs, the registry may determine which AMF to query based on the information indicating that the AMF is managing the access of the UE using an IMS service. The registry may provide further information on the connection provided to the UE by the AMF to the requesting application server. The application server may use the provided information to route communications to the UE (e.g., to terminate a call at the UE).

In the following, certain examples are explained with reference to devices that are often capable of communication via a wireless cellular system and mobile communication systems serving such mobile communication devices. For brevity and clarity, the following describes such examples with reference to a 5G wireless communication system. However, it is understood that such examples are not limited to 5G wireless communication systems, and may, for example, be applied to other wireless communication systems (e.g., current 6G proposals, IEEE 802.11, among others).

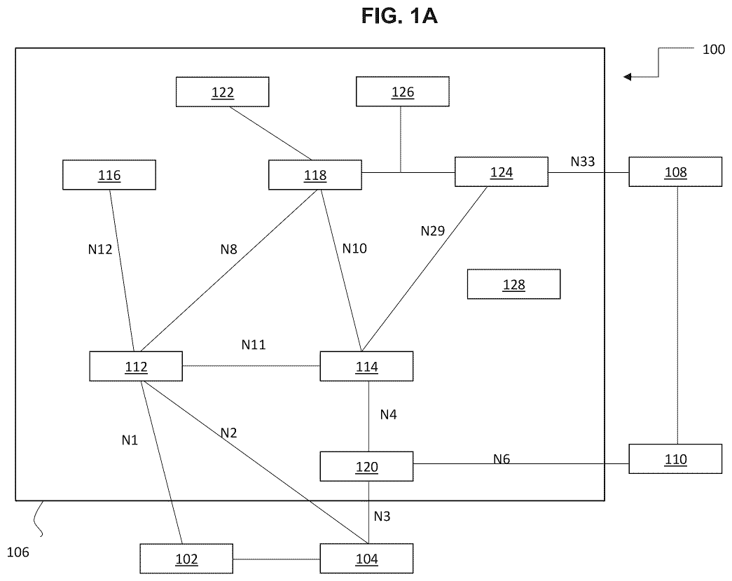

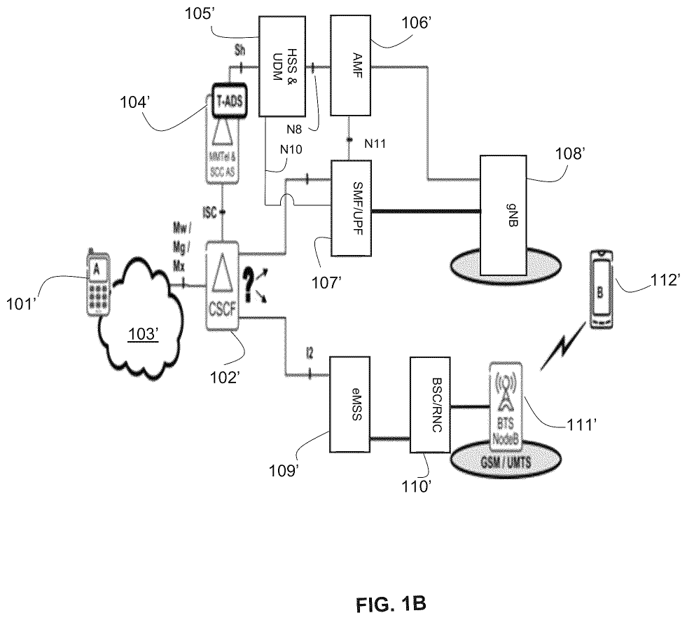

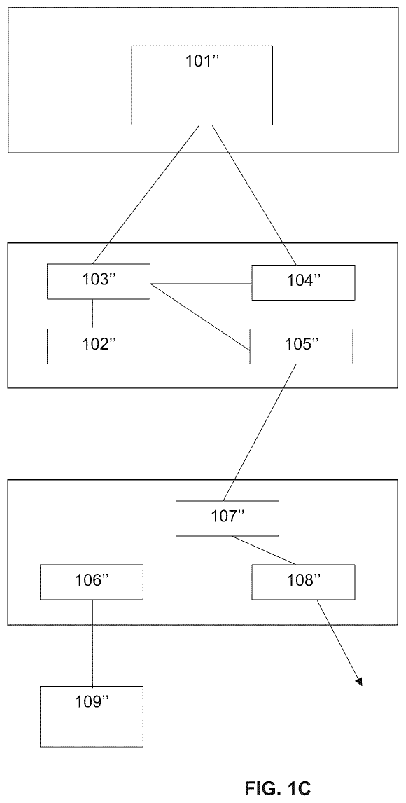

Before describing in detail the examples, certain facets of a 5G wireless communication system are briefly explained with reference to FIGS. 1A to 3.

FIG. 1A shows an example representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110. The UE may subscribe to receive at least one service from an AF. To help facilitate user traffic for the service to be delivered to the UE efficiently, the network may classify user traffic (e.g., Internet Protocol (IP) flows) into different service data flows (SDFs) having different Quality of Service (QoS) classes based on the type of service being provided through the SDFs. Different QoS rules may be applied to each SDF.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

Another example network configuration is illustrated with respect to FIG. 1B.

FIG. 1B illustrates a first UE 101′ that connects to a Call Session Control Function (CSCF) 102′ through an undefined network 103′.

The CSCF 102′ is connected to a Terminating Access Domain Selection (T-ADS) function 104′, which is able to select circuit switched (CS) access and/or one or more packet switched (PS) access network(s) to be used to deliver a terminating session of the UE 101′. Functionality of the T-ADS function is further discussed in 3GPP TS 23.221, 23.292, 23.237, 29.503, and 29.518.

The T-ADS function 104′ is connected to a home subscriber server (HSS) and unified data management 105′, which is in turn connected to an Access and Mobility Management Function (AMF) 106′. The HSS/UDM maintains user profile information for registered subscribers that can be used to authenticate and authorise those registered subscribers. The AMF 106′ interfaces with a Session Management Function (SMF) and/or User Plane Function (UPF) 107′ and an gNB 108′ that operates according to a New Radio-based protocol. The SMF/UPF 107′ also interfaces with the CSCF 102′. The SMF/UPF 107′ and the gNB 108′ may be comprised in a same entity (e.g., an apparatus comprising at least one processor, and at least one memory comprising code that, when executed by the at least one processor, causes the apparatus to perform the functionality of the gNB and the SMF/UPF). The SMF/UPF 107′ and the gNB 108′ may be comprised in different entities (e.g., in different respective apparatus).

The CSCF 102′ further interfaces with an enhanced mobile satellite service (eMSS) 109′, which in turn interfaces to a base station control (BSC) of the radio network controller (RNC) 110′. The BSC-RNC 110′ interfaces with an access node 111′. The access node 111′ operates according to a Global System for Mobile communication (GSM)/Universal Mobile Telecommunications System (UMTS) network, and is shown as signalling to a UE 112′.

3GPP defined an architectural framework for delivering multimedia services (e.g., voice, video, audio, etc.) over an Internet Protocol (IP) network. This architectural framework is called IP Multimedia Subsystem (IMS), and is illustrated with respect to FIG. 1C.

FIG. 1C illustrates a network that comprises an application layer that comprises an application server 101″, a control layer that comprises a HSS 102″, a CSCF 103″, a Media Resource Functions (MRF) 104″, and a Signaling Gateway (SGW)/Media Gateway Control Function (MGCF) (SGW/MGCF) 105″, and a transport layer that comprises an IP network 106″, a gateway 107″ and a public switched telephone network (PSTN) 108″. The IP network 106″ interfaces with a UE 109″. The application server 101″ interfaces with the CSCF 103″ and the MRF 104″. The CSCF 103″ interfaces with the HSS 102″, the MRF 104″ and the SGW/MGCF 105″. The SGW/MGCF 105″ provides interoperability with circuit switched networks, such as the PSTN 108″, by interfacing with the gateway 107″, which, in turn, interfaces with the PSTN 108″.

Under current schemes, any single given UE may be registered in a unified data management (UDM) entity in the core network with a single 3GPP access registration and a single non-3GPP access registration.

For a terminating call (e.g., a call-based operation that ends and/or terminates at a UE), the IMS AS queries the UDM and/or the HSS to request information for use in selecting a terminating domain (e.g., a terminating public land mobile network (PLMN) in which the UE is based). Based on where the UE that is the subject of the terminating call is attached to the network, the UDM and/or HSS provides NR, non 3GPP, LTE, and/or CS access details to the requesting IMS AS. Based on this information, IMS AS may attempt to terminate the IMS calls in the domain(s) where the user is attached. Where the IMS AS is provided with a plurality of different accesses for the UE, the IMS AS may attempt to terminate the IMS call in each access sequentially until the call is successfully terminated at the UE.

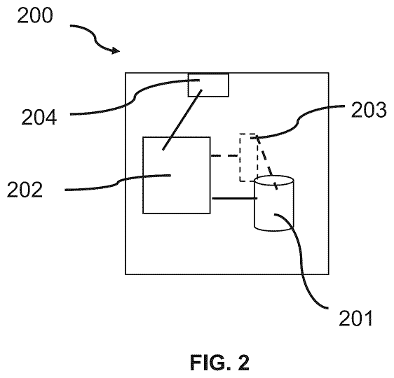

FIG. 2 shows an example of a control apparatus for a communication system, for example to be coupled to and/or for controlling a station of an access system, such as a RAN node, e.g. a base station, gNB, a central unit of a cloud architecture or a node of a core network such as an AMF or UPF, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

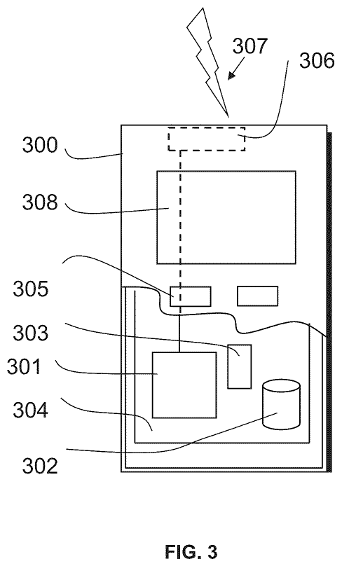

An example wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Some examples comprise a mobile station (MS) or mobile device, such as a mobile phone or what is referred to as a ‘smart phone’, a computer provided with a wireless interface card or other wireless interface facility (e.g., USB dongle), personal data assistant (PDA) or a tablet provided with wireless communication capabilities, or a Virtual Reality device, Augmented Reality device, Mixed Reality device, or other Extended Reality, such as a virtual reality headset, or any combinations of these or the like. A mobile communication device may provide, for example, communication of data for carrying communications such as voice, electronic mail (email), text message, multimedia and extended reality media and so on. Users may thus be offered and provided numerous services via their communication devices. Some examples of these services comprise two-way or multi-way calls, data communication or multimedia services or simply an access to a data communications network system, such as the Internet. Users may also be provided broadcast or multicast data. Some examples of the content comprise downloads, television and radio programs, videos, advertisements, various alerts and other information.

A wireless communication device may, for example, be a mobile device, that is, a device not fixed to a particular location, or it may be a stationary device. The wireless device may utilize human interaction for communication, or may not utilize human interaction for communication. As described herein, the terms UE, or “user” (more informally) can be used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be configured internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface, such as keypad 305, voice commands, touch sensitive screen or pad, combinations thereof or the like. A display or virtual reality headset/glasses 308, a speaker and a microphone can be also provided. Furthermore, a wireless communication device may comprise appropriate connectors (wired and/or wireless) to other devices and/or for connecting external accessories, for example hands-free equipment, thereto.

3GPP has issued a number of releases (Rel) for defining operating communication protocols related to a communications network. Currently, objectives and work are being set in relation to Release 18 (Rel. 18) and Rel. 19.

For example, a study item for Rel. 19 has been issued to study upper layer traffic steering, switching and split over dual 3GPP access.

This study has set a plurality of different objectives.

One objective, for example, is to study additional use cases and potential service requirements that could benefit from 5GS support of upper layer steering, split and switching of UE's traffic (e.g. pertaining to the same data session) across two 3GPP access links, assuming only single subscription to an administrative domain (e.g., a single subscription to a PLMN). This may include at least the cases in which there is a single subscription to: a single PLMN, a PLMN plus a standalone non-public network (NPN), and/or two PLMNs.

The UE may also be able to access network services using a plurality of accesses (e.g., multiple access types of the same or different 3GPP radio access technologies). For example, these may be two radio access technologies that include new radio (NR) plus one of NR, non-terrestrial network (NTN) or LTE, or that include NTN plus one of NR, NTN or LTE. In the present example, NTN may relate to NR-based satellite access, including satellites operating at different orbits (e.g., Geosynchronous Equatorial Orbit (GEO), medium earth orbit (MEO), and/or low earth orbit (LEO).

Another objective relates to the case of providing two administrative domain scenarios (e.g., a PLMN plus a PLMN or an NPN scenario) where the two domains can be managed by the same operator or by different operators that have a business agreement among them.

The study also aims to consider simultaneous connectivity over dual 3GPP access, which assumes UE support of proper radio capabilities (e.g., dual radio).

To help facilitate coordination of multi-network scenarios, a T-ADS function may provide T-ADS information across various network elements. T-ADS information relates to an information element that indicates a radio access type that is serving a UE and that further indicates whether or not an IMS voice over packet switched session is supported at a current routing area and/or tracking area associated with the UE. T-ADS information about a user and/or UE may be obtained by an application server from a HSS and/or a UDM using a “read” operation.

For example, 3GPP TS 29.328 describes operations that may be used by an application server to retrieve information from a HSS. For example, an application server may signal a T-ADS request to a HSS. When receiving the T-ADS request from the Application Server, the HSS may check whether serving nodes (e.g., Serving General Packet Radio Service (GPRS) Support Node (SGSN) and/or Mobility Management Entity (MME) nodes) are registered for the user at the HSS.

In general, if no serving nodes are registered, a response indicating that IMS voice over PS sessions is not supported may be returned to the Application Server. UE Activity Time and the Last RAT Type are not reported.

If all serving nodes are registered (e.g., both MME and SGSN are registered), a response indicating that IMS voice over PS sessions is supported may be returned to the application server. The response may comprise an indication of a response from MME or SGSN (whichever reported the most recent UE Activity Time) to indicate a most recent UE Activity Time and the Last RAT Type are also reported.

In some examples, the response may comprise an indication that it is unknown whether IMS voice over PS sessions is supported. More detail on these procedures is discussed in 3GPP TS 29.328.

During an IMS terminating call, the IMS Server (e.g., a Service Centralization and Continuity Application Server (SCC AS)) requests T-ADS Information for a user equipment from an HSS. In response to the request, the HSS may obtain the T-ADS Information from the UDM. For example, the HSS may forward the request to the UDM. In some examples, the HSS and UDM may be the same entity or different entities. However, when there are multiple registrations available in UDM, it is unclear how the UDM and/or HSS can determine which access network is better for the termination call.

Further, even if a HSS and/or UDM can determine a “best” access network to provide details of to the requesting SCC AS, it is unclear how the SCC AS can terminate the call to multiple accesses.

In the following and as described herein, mechanisms for addressing at least one of the above-mentioned issues are provided.

As part of these mechanisms, each UE registration may have (e.g., is assigned) a specific registration identifier, which is provided to a UDM for registration. The registration identifier may identify the UE registration to the 5GC. For example, for a first registration where the UE registers with an AMF for 5GC access over RAN1, the first registration may have a first registration identifier, and for a second registration where the UE registers with the AMF for 5GC access over RAN2, the second registration may have a second registration identifier, and so on. This registration identifier may be used by the UDM in a variety of ways for identifying the AMF that provides an IMS access to the UE.

For example, consider the case in which an AMF and SMF provide information that can be used by the UDM to identify the AMF.

In general, the Nudm_UECM_Registration service operation is used by NFs (e.g., by any of an AMF, an SMF, etc.) to register at the UDM as the NF serving the UE (e.g., AMF) or the NF serving a PDU session (e.g., SMF).

For example, the AMF may use the Nudm_UECM_Registration message to register as the serving NF for a UE's access and mobility management service during registration. Further, the SMF may use the Nudm_UECM_Registration message to register as the serving NF for session management services during PDU Session establishment.

The NF invoking the Nudm_UECM_Registration Service Operation may provide a plurality of identifiers to the UDM for registration, including an NF identifier (which uniquely identifies the NF), an NF type identifier (which identifies the type of NF), and an identifier of the UE (e.g., a global identifier, such as a subscriber identifier of the UE). The UDM authorizes the request and, if accepted, the NF is registered in the UDM as the NF serving the UE.

According to the subject disclosure, the AMF associates a registration identifier with the AMF's registration at the UDM for a UE, and may provide that registration identifier to an SMF when the AMF is establishing a session on behalf of the user equipment (e.g., when establishing a PDU session during a PDU session establishment procedure). The SMF may subsequently provide this registration identifier to the UDM during the SMF Registration procedure (e.g., using the Nudm_UECM_Registration Service operation).

Further, during the PDU session registration procedure, the SMF may provide an indication to the UDM that the PDU session or this SMF registration is to be used for IMS during the registration procedure. When an indication is not provided by the SMF to the UDM, the UDM may derive this information from other information provided to the UDM during setup of an IMS PDU session (e.g., a data network name (DNN) and/or single-network slice selection assistance information (S-NSSAI)). The UDM may identify which AMF is to be used for IMS by correlating the registration identifiers received in the different operations and by using the information comprised in the SMF registration request that identifies that registration identifier as being for IMS.

For example, there may be provided a first registration request from a network function (e.g., an SMF and/or an AMF) that comprises information indicating that a registration identifier for a UE is associated with an IMS service.

When a request for information regarding which AMF serves the UE for IMS is later received by the UDM from an application server via the HSS (e.g., when the UDM subsequently receives a T-ADS query, via the HSS), the UDM selects an AMF registration having a registration identifier that matches the registration identifier received in the SMF registration for the identified IMS PDU session. Information associated with that AMF registration may be selected for responding to the request for information. For example, information may be provided with respect to which access was last used by the UE for that AMF registration and when that access was last used by the UE.

As an alternative example, instead of the SMF providing an indication of the IMS provision, the AMF may directly signal information indicating that AMF's provision of an IMS suitable access to the UE as part of the AMF's registration information.

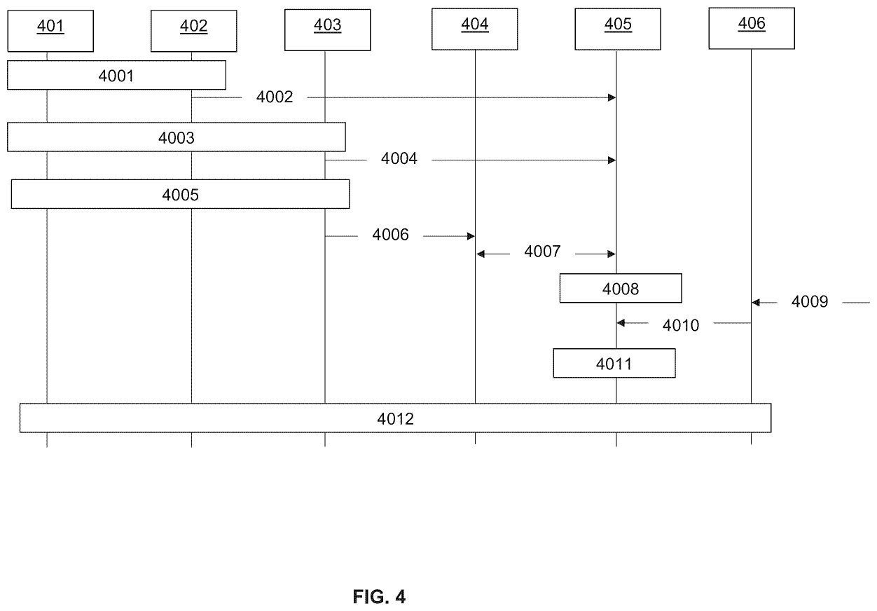

These features are illustrated with respect to FIGS. 4 to 10.

FIG. 4 illustrates example signalling that may be performed in a first scenario in which a UE has multiple registrations for a same access network via different AMFs.

FIG. 4 illustrates signalling that may be performed between a UE 401, a first AMF 402, a second AMF 403, an SMF 404, a UDM/HSS 405, and an application server (AS) 406. The application server may comprise an IMS AS. The application server may comprise an SCC AS.

During 4001, the UE 401 and the first AMF 402 exchange signalling for enabling (or otherwise facilitating) the UE to attach to a first radio access network associated with the first AMF 402 and/or to attach to the first AMF 402. This signaling may contain a first registration identifier.

During 4002, the first AMF 402 signals the UDM/HSS 405. This signalling may comprise a first registration identifier. The first registration identifier may identify the UE's registration to the 5GC via the first radio access network. This signalling may comprise an Nudm_UECM_Registration message.

During 4003, the UE 401 and the second AMF 403 exchange signalling for enabling (or otherwise facilitating) the UE to attach to a second radio access network associated with the second AMF 403 and/or to attach to the second AMF 403. This signaling may contain a second registration identifier. The UE 401 and/or the second AMF 403 may determine during this procedure (e.g., identify to the other entity) that the registration of 4003 is for IMS registration.

During 4004, the second AMF 403 signals the UDM/HSS 405. This signalling may comprise the second registration identifier. This signalling may be provided using, for example, an Nudm_UECM_Registration message.

During 4005, the UE 401 signals the second AMF 403. This signalling may relate to initiating a session (e.g., initiating an IMS PDU session).

During 4006, the second AMF 403 signals the SMF 404. This signalling may comprise a PDU session related request. This PDU session related request may relate to establishing a PDU session targeting IMS services. The signalling of 4006 may comprise the second registration identifier. For example, the second AMF 403 may signal the second registration identifier to the SMF 404 regardless of the DNN of the PDU Session.

During 4007, the SMF 404 signals the UDM/HSS 405. This signalling may comprise the second registration identifier. This signalling may comprise an indication that the PDU Session and/or SMF is being registered for an IMS session. The signalling of 4007 may comprise an Nudm_UECM_Registration message. Stated differently, the SMF 404 may perform session registration at the UDM/HSS and provide at least the second registration identifier.

During 4008, the UDM/HSS 405 stores the second registration identifier with an indication that the session associated with that registration identifier is for IMS services. This may be performed by storing the second registration identifier and the indication at a UDR. Where an indication that the PDU session and/or SMF is being registered for an IMS is not provided during 4007, the UDM/HSS 405 may infer that the registration is for an IMS session using a combination of the DNN and slice information (e.g., S-NSSAI) associated with that SMF registration.

During 4009, the application server 406 receives an indication of a terminating call coming in for the UE 401.

During 4010, the application server 406 signals the UDM/HSS 405. This signalling may comprise a request for T-ADS information in relation to the UE.

In some examples, the signalling may request at least one of the following:
the time of the last radio contact of the UE, for the corresponding registration identifier;
whether or not IMS voice over PS session is supported in the registration area (s) where the UE is currently registered, for the corresponding registration identifier;
whether or not IMS voice over PS Session Supported Indication over non-3GPP access is supported in the Wireless Local Area Network (WLAN) where the UE is currently registered, for the corresponding registration identifier; or
the current Access Type and Radio Access Technology (RAT type), for the corresponding registration identifier.

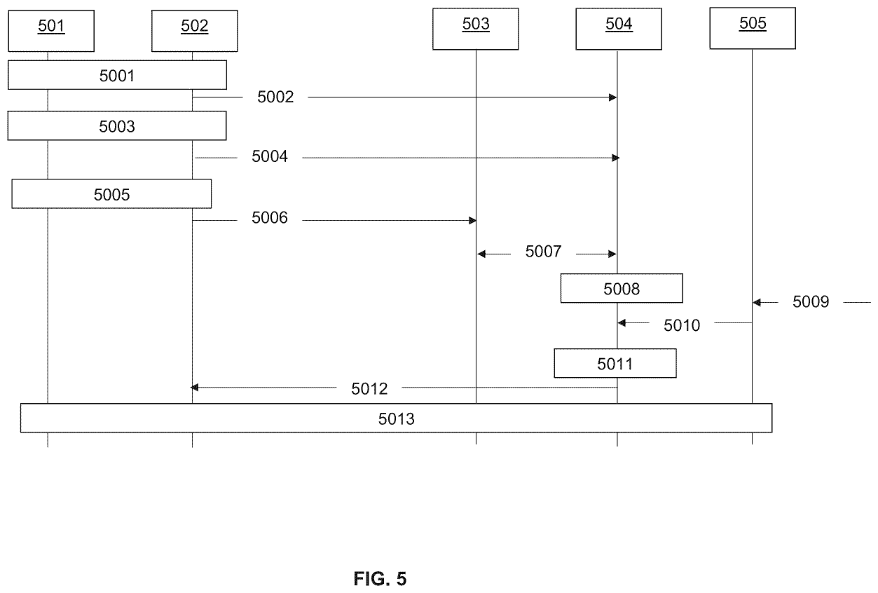

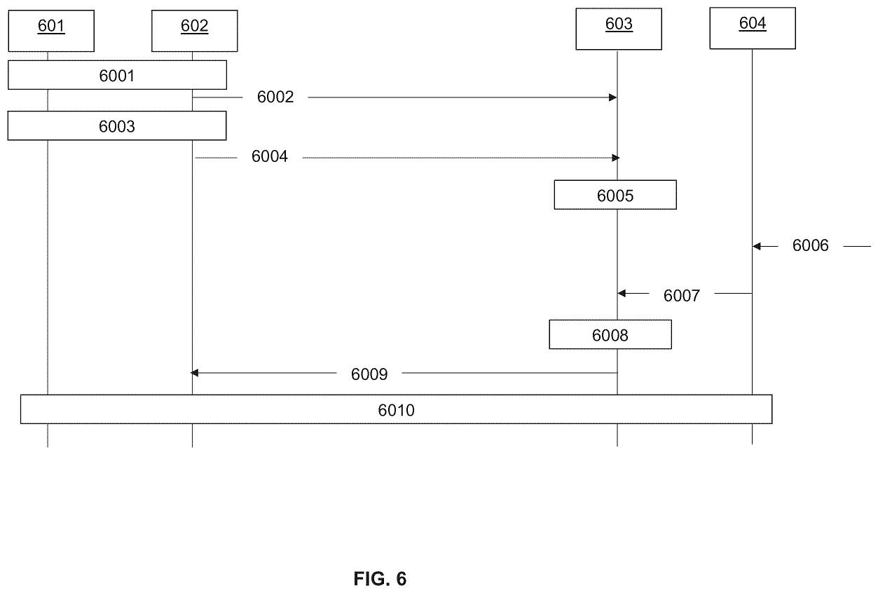

The signalling may comprise, for example, an Sh-data read operation (e.g., Sh-PULL and/or Nhss imsSubscriberDataManagement_Get operations, see 3GPP TS 29.328, and 3GPP TS 29.562). As an example, Sh-PULL is a procedure used between an application server and a HSS that is invoked by the AS to read data for a specified user from the HSS. It is therefore understood that any operation or protocol that can be used by an application server to obtain information about a user of a UE and/or a UE can be used during 4010, or during analogous functions (e.g., in FIG. 5 and/or FIG. 6).

During 4011, the UDM selects an AMF registration having a registration identifier that matches the registration identifier received in the SMF registration for the IMS PDU session and uses that AMF registration for T-ADS purposes.

During 4012, the UDM/HSS 405 selects the AMF associated with the selected AMF registration of 4011 and sends a query to the second AMF 403 to obtain the last active time of the UE. This query may comprise, for example, an Namf_MT_ProvideDomainSelectionInfo Request service operation (see, for example, 3GPP TS 23.502 and TS 29.518). If desired, the UDM/HSS 405 may be configured to contact the HSS or the MME to determine information relating to the other access details. Then, UDM/HSS 405 may provide a consolidated response to application server 406 that comprises information for allowing the application server 406 to cause the call to be terminated to the selected access/registration.

FIG. 5 illustrates an example scenario relating to providing T-ADS information when there are multiple registrations for the same access at a same AMF.

FIG. 5 illustrates signalling that may be performed between a UE 501, a first AMF 502, an SMF 503, a UDM/HSS 504, and an application server (AS) 505. The application server may comprise an IMS AS. The application server may comprise an SCC AS.

During 5001, the UE 501 and the first AMF 502 exchange signalling for enabling (or otherwise facilitating) the UE to attach to a first radio access network associated with the first AMF 502 and/or to attach to the first AMF 502. This signaling may contain a first registration identifier.

During 5002, the first AMF 502 signals the UDM/HSS 504. This signalling may comprise a first registration identifier. The first registration identifier may identify the combination of the UE 501 and the first radio access network. This signalling may comprise an Nudm_UECM_Registration message.

During 5003, the UE 501 and the first AMF 502 exchange signalling for enabling (or otherwise facilitating) the UE to issue another attach to a second radio access network associated with the first AMF 502. This signaling may contain a second registration identifier. The UE 501 and/or the first AMF 502 may determine during this procedure (e.g., identify to the other entity) that the registration of 5003 is for IMS registration.

During 5004, the first AMF 502 signals the UDM/HSS 504. This signalling may comprise the second registration identifier. The second registration identifier may identify the combination of the UE 501 and the second radio access network. This signalling may comprise an Nudm_UECM_Registration message.

During 5005, the UE 501 signals the first AMF 502. This signalling may relate to initiating a session (e.g., an IMS PDU session).

During 5006, the first AMF 502 signals the SMF 503. This signalling may comprise a PDU session related request. This PDU session related request may relate to establishing a PDU session for IMS services. The signalling of 5006 may comprise the second registration identifier. For example, the first AMF 502 may signal the second registration identifier to the SMF 503 regardless of the DNN of the PDU Session.

During 5007, the SMF 503 signals the UDM/HSS 504. This signalling may comprise the second registration identifier. This signalling may comprise an indication that the PDU Session and/or SMF is being registered for an IMS session. The signalling of 5007 may comprise an Nudm_UECM_Registration message. Stated differently, the SMF 503 may perform session registration at the UDM/HSS and provide at least the second registration identifier.

During 5008, the UDM/HSS 504 stores the second registration identifier with an indication that the session associated with that registration identifier is for IMS services. This may be performed by storing the second registration identifier and the indication at a UDR. Where an indication that the PDU and/or SMF is being registered for an IMS is not provided during 5007, the UDM/HSS 504 may infer that the registration is for an IMS session using a combination of the DNN and slice information (e.g., S-NSSAI) associated with that SMF registration.

During 5009, the application server 505 receives an indication of a terminating call coming in for the UE 501.

During 5010, the application server 505 signals the UDM/HSS 504. This signalling may comprise a request for T-ADS information in relation to the UE. The signalling may comprise, for example, an Sh-data read operation (e.g., Sh-PULL and/or Nhss imsSubscriberDataManagement_Get operations, see 3GPP TS 29.328, and 3GPP TS 29.562).

During 5011, the UDM selects AMF registration having a registration identifier that matches the registration identifier received in the SMF registration for the IMS PDU session and uses that AMF registration for T-ADS purposes.

During 5012, the UDM/HSS 504 signals the first AMF 502. This signalling may request a “last active time” for the second AMF/registration.

As both registrations are held in the same AMF (the first AMF 502), the UDM/HSS may inform the AMF for which registration T-ADS information is being requested by including the registration identifier (e.g., the second registration identifier in the present example) in the signalling to the first AMF 502. The signalling of 5012 may be comprised in a Provide Domain Selection information request (e.g., an Namf_MT_ProvideDomainSelectionInfo Request (see 3GPP TS 23.502 and 3GPP TS 29.518).

This signalling may request at least one of the following:
the time of the last radio contact of the UE, for the corresponding registration identifier;
whether or not IMS voice over PS session is supported in the registration area (s) where the UE is currently registered, for the corresponding registration identifier;
whether or not IMS voice over PS Session Supported Indication over non-3GPP access is supported in the WLAN where the UE is currently registered, for the corresponding registration identifier; or
the current Access Type and RAT type, for the corresponding registration identifier.

Although not shown, the first AMF 502 may provide at least one of the above-mentioned information requested during 5012. The AMF may select a registration to consider in order to provide the information to provide to the UDM as part of Namf_MT_ProvideDomainSelectionInfo Request for T-ADS (e.g., the registration associated with the second registration identifier).

During 5013, the UDM/HSS 504 selects the first AMF and sends a query to the first AMF 502 to find out the last active time of the UE. If desired, the UDM/HSS 504 may be configured to contact the HSS or the MME to determine information relating to the other access details. Then UDM/HSS 504 may provide a consolidated response to application server 505 that comprises information for allowing the application server 505 to cause the call to be terminated to the selected access/registration.

FIG. 6 illustrates an example scenario relating to providing T-ADS information when there are multiple registrations for the same access at a same AMF.

FIG. 6 illustrates signalling that may be performed between a UE 601, a first AMF 602, a UDM/HSS 603, and an application server (AS) 604. The application server may comprise an IMS AS. The application server may comprise an SCC AS.

During 6001, the UE 601 and the first AMF 602 exchange signalling for enabling (or otherwise facilitating) the UE to attach to a radio access network associated with the first AMF 602 and/or to attach to the first AMF 602. This signaling may contain an indication from the UE that the registration is intended to be used for IMS service.

During 6002, the first AMF 602 signals the UDM/HSS 603. This signalling may comprise a first registration identifier. This signalling may comprise an indication that this first registration identifier is to be used for IMS. This signalling may comprise an Nudm_UECM_Registration message.

During 6003, the UE 601 and the first AMF 602 exchange signalling for enabling (or otherwise facilitating) the UE to attach to a second radio access network associated with the first AMF 602.

During 6004, the first AMF 602 signals the UDM/HSS 603. This signalling may comprise a second registration identifier. This signalling may comprise an Nudm_UECM_Registration message. This signalling may not include an indication that the second registration identifier is for IMS registration.

During 6005, the UDM/HSS 603 stores the first registration identifier with an indication that the first registration identifier is associated with providing IMS services to the UE 601. This may be performed by storing the first registration identifier and the indication at a UDR. The UDM/HSS 603 stores the second registration identifier with an indication that the second registration identifier is not associated with providing IMS services to the UE 601.

During 6006, the application server 604 receives an indication of a terminating call coming in for the UE 601.

During 6007, the application server 604 signals the UDM/HSS 603. This signalling may comprise a request for T-ADS information in relation to the UE. The signalling may comprise, for example, an Sh-data read operation (e.g., Sh-PULL and/or Nhss imsSubscriberDataManagement_Get operations, see 3GPP TS 29.328, and 3GPP TS 29.562).

During 6008, the UDM selects an AMF registration having a registration identifier that is associated with IMS provision (e.g., the first registration identifier, which was provided via the signalling of 6001) and uses that AMF registration for T-ADS purposes (e.g., information relating to the first registration identifier is obtained and returned to the application server/HSS).

During 6009, the UDM/HSS 603 signals the first AMF 602. This signalling may request a “last active time” for the second AMF/registration.

As both registrations are held in the same AMF (the first AMF 602), the UDM/HSS may inform the AMF for which registration T-ADS information is being requested by including the registration identifier (e.g., the second registration identifier in the present example) in the signalling to the first AMF 602. The signalling of 6009 may be comprised in a Provide Domain Selection information request (e.g., an Namf_MT_ProvideDomainSelectionInfo Request (see 3GPP TS 23.602 and 3GPP TS 29.518).

This signalling may request at least one of the following:
the time of the last radio contact of the UE, for the corresponding registration identifier;
whether or not IMS voice over PS session is supported in the registration area (s) where the UE is currently registered, for the corresponding registration identifier;
whether or not IMS voice over PS Session Supported Indication over non-3GPP access is supported in the WLAN where the UE is currently registered, for the corresponding registration identifier; or
the current Access Type and RAT type, for the corresponding registration identifier.

Although not shown, the first AMF 602 may provide at least one of the above-mentioned information requested during 6008. The AMF may select a registration to consider in order to provide the information to provide to the UDM as part of Namf_MT_ProvideDomainSelectionInfo Request for T-ADS.

During 6010, the UDM/HSS 603 selects the AMF associated with the selected AMF registration of 6008, and sends a query to the first AMF 603 to obtain the last active time of the UE. If desired, the UDM/HSS 603 may be configured to contact the HSS or the MME to determine information relating to the other access details. Then UDM/HSS 603 may be configured to provide a consolidated response that comprises information for allowing the application server 604 to cause the call to be terminated to the selected access/registration.

As a variant of any of the examples of FIG. 4, FIG. 5, and/or FIG. 6, the AMF (403/502/602) may implicitly determine that a registration of the UE (401/501/601) is for access to an IMS service (e.g., the AMF may determine that a registration of the UE is for access to an IMS service without the UE signalling an indication that the registration is for access to an IMS service).

For example, the AMF may receive, in association with a registration of a UE (401/501/601), signalling associated with a PDU session (e.g. a Non-Access Stratum (NAS) PDU Session establishment request from the UE or inter-AMF mobility signalling) towards a data network name (DNN) and/or single-network slice selection assistance information (S-NSSAI) associated with an IMS service. The AMF may use this received information to determine that the associated registration is for IMS services, and signal this information to the UDM/HSS (405/504/603). This signalling from the AMF may comprise a registration identifier corresponding to a registration identifier associated with the UE via a specific access network node. This signalling from the AMF may comprise an indication that this registration identifier is to be used for providing IMS services to the UE. This signalling may comprise an Nudm_UECM_Update message.

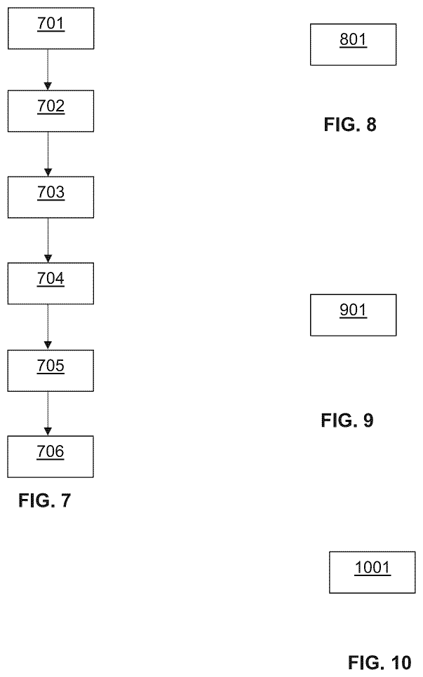

FIGS. 7 to 10 illustrate operations that may be performed by apparatus described herein. These operations may correspond to features described above in relation to the provided examples. It is understood that the above examples may be used to illustrate how to the following described features may be implemented in at least one environment, and that correspondence may be found between the functionality mentioned below and at least one feature of the above examples. It is further understood that features of any of FIGS. 7 to 10 that are labelled the same as features in another of the Drawings may be corresponding features.

FIG. 7 illustrates operations that may be performed by an apparatus for a unified data management function. The apparatus may be configured to operate as a unified data management function. For example, the apparatus may be configured to perform one or more functions of a unified data management function.

During 701, the apparatus receives, from a first access and mobility management function, a first registration request for registering that the first access and mobility management function is to serve a user equipment, the first registration request comprising a first registration identifier.

The apparatus may receive another (second) registration request for registering that either the first access and mobility function or a second access and mobility function is to serve the user equipment, the second registration request comprising a second registration identifier. The apparatus may maintain information on the first and second registrations at the same time (e.g., concurrently and/or simultaneously).

During 702, the apparatus receives information indicating that the registration corresponding to the first registration request is associated with an internet protocol multimedia subsystem, IMS, service.

During 703, the apparatus receives, from a network entity, a request for information related with an IMS service. The request may comprise a request for T-ADS information.

During 704, the apparatus determines a registration identifier and access and mobility management function for the related IMS service.

During 705, the apparatus obtains said information for the related IMS service from the determined access and mobility management function by providing the determined registration identifier to the determined access and mobility management function. The determined access and mobility management function may respond to the request comprising the determined registration identifier with the requested information.

During 706, the apparatus provides the requested information (e.g., the obtained information) to the network entity.

Stated differently, the apparatus of FIG. 7 may determine the first access and mobility management function as being an AMF that provides the user equipment with an IMS service based on the received information and the received first registration request, and provide the identifier of the first access and mobility to the network function based on this determination.

The apparatus may receive the information indicating that the registration corresponding to the first registration request is associated with an IMS service by receiving a second registration request for said user equipment, the second registration request comprising the first registration identifier and information indicating that the packet data unit session is for an IMS service.

The apparatus may receive the information indicating that the registration corresponding to the first registration request is associated with an IMS service by receiving, from a session management function, the second registration request, the second registration request comprising information for registering that the session management function is to serve a packet data unit session for said user equipment, the second registration request comprising the first registration identifier and information indicating that the packet data unit session is for an IMS service.

The apparatus may store, for the user equipment, an association between the related IMS service and the received information indicating that the registration corresponding to the first registration request is associated with the IMS session.

The apparatus may identify the first access and mobility management function in response to the request for information by retrieving the stored association.

The information indicating that the session is for an IMS service may comprise an indication that the session is for an IMS service.

The information indicating that the session is for an IMS service may comprise a data network name and/or a network slice identifier usable for the IMS service. This combination of information may be used for determining that the session associated with this data network name and/or a network slice identifier is usable for IMS.

The apparatus may receive the information indicating that the registration corresponding to the first registration request is associated with an IMS service by receiving, in the first registration request, information indicating that the registration corresponding to the first registration request is associated with an IMS service.

The apparatus may identify the first access and mobility management function in response to the request for information by retrieving the stored association.

The information indicating that the session is for an IMS service may comprise an indication that the session is for an IMS service.

The network entity may comprise a home subscriber system or an application server.

The apparatus may signal, to the first access and mobility management function, a request for information associated with the first registration identifier, and receive, from the first access and mobility management function, the requested information associated with the first registration identifier. The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

FIG. 8 illustrates operations that may be performed by an apparatus for an access and mobility management function. The apparatus may be configured to operate as an access and mobility management function. For example, the apparatus may be configured to perform one or more functions of an access and mobility management function.

During 801, the apparatus provides, to a unified data management function, a first registration request for registering that an access and mobility management function is to serve a user equipment, the first registration request comprising a first registration identifier.

The first registration request may comprise information indicating that the registration identifier is associated with an Internet Protocol Multimedia Subsystem, IMS, service.

The apparatus may receive, from the user equipment, information indicating that the first registration request is associated with the user equipment's registration to a core network for an internet protocol multimedia subsystem, IMS, service.

The apparatus may determine that the first registration request is associated with an internet protocol multimedia subsystem, IMS, service based on a PDU session established for the user equipment for a data network name and/or a network slice identifier corresponding to the IMS service.

The information indicating that the session is for an IMS service may comprise an indication that the session is for an IMS service, wherein the indication is based on the information received from the user equipment.

The apparatus may receive, from the unified data management function, a request for information associated with the first registration identifier, and signal, to the unified data management function, the requested information associated with the first registration identifier.

The information associated with the first registration identifier may comprise at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

The apparatus may provide the first registration identifier to a session management function in a packet data unit session establishment or modification request signaled to the session management function.

FIG. 9 illustrates operations that may be performed by an apparatus for a session management function. The apparatus may be configured to operate as a session management function. For example, the apparatus may be configured to perform one or more functions of a session management function.

During 901, the apparatus provides, to a unified data management function, a second registration request for registering that the session management function is to serve a packet data unit session for a user equipment, the second registration request comprising a first registration identifier, wherein the second registration request comprises information indicating that the packet data unit session is associated with an Internet Protocol Multimedia Subsystem, IMS, service.

The apparatus may receive the first registration identifier from an access and mobility management function that is to serve said user equipment in a packet data unit session establishment or a packet data unit session modification request.

The information indicating that the session is for an IMS service may comprise an indication that the session is for an IMS service.

The information indicating that the session is for an IMS service may comprise a data network name and/or a network slice identifier usable for the IMS service.

FIG. 10 illustrates operations that may be performed by an apparatus for a user equipment. The apparatus may be comprised in or implemented by the user equipment.

During 1001, the apparatus sends, to an access and mobility management function, information indicating that a first registration is associated with the user equipment's registration to a core network for an internet protocol multimedia subsystem, IMS, service.

It is understood that references in the above to various network functions (e.g., to an AMF, an SMF, etc.) may comprise apparatus that perform at least some of the functionality associated with those network functions. Further, an apparatus, configured to operate as a network function, may comprise a virtual network function instance of that network function. In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) Internet Protocol multimedia subsystems (IMS) and expected 6G systems or any combination thereof.

As provided herein, various examples are described in the detailed description. In general, some examples may be implemented in hardware or special purpose circuits, software code, logic or any combination thereof. For example, some examples may be implemented in hardware, while other examples may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as some examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, in some examples.

Further in this regard it should be noted that any procedures, e.g., as in FIG. 7, and/or FIG. 8, and/or FIG. 9, and/or FIG. 10, and/or otherwise described herein, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used herein, the term “circuitry” may refer to one or more or all of the following examples:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the subject disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

The term “non-transitory,” as used herein, is a limitation of the medium itself (e.g., tangible, not a signal) as opposed to a limitation on data storage persistency (e.g., RAM vs. ROM).

The scope of protection sought for various examples of the subject disclosure is set out by the independent claims. The examples and features, if any, described herein that do not fall under the scope of the independent claims are to be interpreted as examples useful for understanding the subject disclosure.

The foregoing description has provided, by way of non-limiting and illustrative examples, a full and informative description of example implementations of this subject disclosure. However, various modifications and adaptations may become apparent to those skilled in the relevant arts in view of the foregoing description, when read in conjunction with the accompanying drawings and the claims. However, all such and similar modifications of the teachings of this subject disclosure will still fall within the scope of the examples described herein. Indeed, there is a further implementation comprising a combination of one or more examples with any of the other examples described herein.

1. An apparatus comprising: at least one processor; and at least one memory storing instructions that, when executed by the at least one processor, cause the apparatus at least to perform:
receiving, from a first access and mobility management function, a first registration request for registering that the first access and mobility management function is to serve a user equipment, the first registration request comprising a first registration identifier;
receiving information indicating that the registration corresponding to the first registration request is associated with an internet protocol multimedia subsystem, IMS, service;
receiving, from a network entity, a request for information related with an IMS service;
determining a registration identifier and access and mobility management function for the related IMS service;
obtaining said information for the related IMS service from the determined access and mobility management function by providing the determined registration identifier to the determined access and mobility management function; and
providing the requested information to the network entity.

2. An apparatus as claimed in claim 1, wherein the receiving information indicating that the registration corresponding to the first registration request is associated with an IMS service, wherein the apparatus is further caused to perform:
receiving a second registration request for said user equipment, the second registration request comprising the first registration identifier and information indicating that the packet data unit session is for an IMS service.

3. An apparatus as claimed in claim 2, wherein the receiving information indicating that the registration corresponding to the first registration request is associated with an IMS service, wherein the apparatus is further caused to perform:
receiving, from a session management function, the second registration request, the second registration request comprising information for registering that the session management function is to serve a packet data unit session for said user equipment, the second registration request comprising the first registration identifier and information indicating that the packet data unit session is for an IMS service.

4. An apparatus as claimed in claim 3, wherein the apparatus is further caused to perform: storing, for the user equipment, an association between the related IMS service and the received information indicating that the registration corresponding to the first registration request is associated with the IMS session.

5. An apparatus as claimed in claim 4, wherein the apparatus is further caused to perform:
identifying the first access and mobility management function in response to the request for information by retrieving the stored association.

6. An apparatus as claimed claim 2, wherein the information indicating that the session is for an IMS service comprises an indication that the session is for an IMS service.

7. An apparatus as claimed claim 2, wherein the information indicating that the session is for an IMS service comprises a data network name and/or a network slice identifier usable for the IMS service.

8. An apparatus as claimed in claim 1, wherein receiving information indicating that the registration corresponding to the first registration request is associated with an IMS service comprises means for: receiving, in the first registration request, information indicating that the registration corresponding to the first registration request is associated with an IMS service.

9. An apparatus as claimed in claim 8, wherein the information indicating that the session is for an IMS service comprises an indication that the session is for an IMS service.

10. An apparatus as claimed in claim 1, wherein the network entity is configured to operate as a home subscriber system or an application server.

11. An apparatus as claimed in claim 1, wherein the obtaining comprises performing:
signalling, to the first access and mobility management function, a request for information associated with the first registration identifier; and
receiving, from the first access and mobility management function, the requested information associated with the first registration identifier.

12. An apparatus as claimed in claim 11, wherein the information associated with the first registration identifier comprises at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

13. An apparatus comprising: at least one processor; and at least one memory storing instructions that, when executed by the at least one processor, cause the apparatus at least to perform:
providing, to a unified data management function, a first registration request for registering that an access and mobility management function is to serve a user equipment, the first registration request comprising a first registration identifier, wherein the apparatus is comprised in the access and mobility management function.

14. An apparatus as in claim 13, wherein the first registration request comprises information indicating that the registration identifier is associated with an Internet Protocol Multimedia Subsystem, IMS, service.

15. An apparatus as claimed in claim 14, wherein the apparatus is further caused to perform:
receiving, from the user equipment, information indicating that the first registration request is associated with the user equipment's registration to a core network for an internet protocol multimedia subsystem, IMS, service; or
determining that the first registration request is associated with an internet protocol multimedia subsystem, IMS, service based on a packet data unit session established for the user equipment for a data network name and/or a network slice identifier corresponding to the IMS service.

16. An apparatus as claimed in claim 15, wherein the information indicating that the session is for an IMS service comprises an indication that the session is for an IMS service, wherein the indication is based on the information received from the user equipment.

17. An apparatus as claimed in claim 13, wherein the apparatus is further caused to perform:
receiving, from the unified data management function, a request for information associated with the first registration identifier; and
signalling, to the unified data management function, the requested information associated with the first registration identifier.

18. An apparatus as claimed in claim 15, wherein the information associated with the first registration identifier comprises at least one of the following: a last active time of the user equipment for the registration corresponding to the first registration request; a last active access type used by the user equipment for the registration corresponding to the first registration request; or an indication of whether IMS voice over a packet switched session is supported in an area in which the user equipment is registered for the registration corresponding to the first registration request.

19. An apparatus as claimed in claim 12, wherein the apparatus is further caused to perform providing the first registration identifier in a packet data unit session establishment or modification request to a session management function.

20. An apparatus, comprising: at least one processor; and at least one memory storing instructions that, when executed by the at least one processor, cause the apparatus at least to perform:
sending, to an access and mobility management function, information indicating that a first registration is associated with the user equipment's registration to a core network for an internet protocol multimedia subsystem, IMS, service, wherein the apparatus is comprised in a user equipment.
